(19) United States
(12) Patent Application Publication
(10) Pub. No.: US 2008/0314008 A1
(43) Pub. Date: Dec. 25, 2008

(54) Filter Element and Filter for Exhaust-Gas Aftertreatment

(75) Inventors: Teruo Komori, Stuttgart (DE); Bernd Reinsch, Ludwigsburg (DE); Christian Schiller, Renningen (DE); Lars Thuener, Stuttgart (DE); Dominik Huelsmeier, Stuttgart (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 12/089,428

(22) PCT Filed: Sep. 29, 2006
(86) PCT No.: PCT/EP2006/066921

§ 371 Date: Aug. 14, 2008

(30) Foreign Application Priority Data
Oct. 5, 2005 (DE) 10 2005 047 598.1

(51) Int. Cl. B01D 29/11

(52) U.S. Cl. 55/385.3; 428/188; 55/524; 428/157; 55/495

(57) ABSTRACT

A filter element for an exhaust-gas aftertreatment device of an internal combustion engine is provided, which is made of a coated ceramic material and thus is more robust with respect to local overheating.

### BACKGROUND INFORMATION

The present invention relates to a filter element for purifying the exhaust gases of an internal combustion engine according to the definition of the species in claim 1, and to a carbon-particulate filter having a filter element as recited in the other independent claim 15. Such filter elements are used as particulate filter for diesel gasoline engines, for example.

The filter elements are often made of a ceramic material and have a multitude of inlet channels and exit channels, which extend parallel to each other.

Filter elements are made of ceramic materials and produced by extrusion. This means that the blank of the filter element is a prism-shaped body having a multitude of channels extending parallel to each other. In the beginning the channels of a blank are open at both ends.

To allow the exhaust gas to be purified to flow through the walls of the filter, a portion of the channels is sealed at the back end of the filter element while another portion of the channels is sealed at the front end of the filter element. This creates two groups of channels, i.e., what is referred to as inlet channels, which are sealed at the back end, and what is referred to as exit channels, which are sealed at the front of the filter element.

A flow connection between the inlet channels and the exit channels is possible exclusively via the porous walls of the filter element, so that the exhaust gas can flow through the filter element only by flowing out of the inlet channels, through the walls of the filter elements, and into the exit channels.

In the regeneration of the filter elements the particulate deposits are oxidized, and heat is released in the process. Since more carbon particulate is deposited in the interior of the filter elements than at its periphery. Furthermore, since the heat dissipation is better at the periphery of the filter element than in its interior, local temperature differences arise, especially in the regeneration of the filter element, which lead to thermal stresses inside the filter element.

When the thermal stresses become too great, the filter element cracks, which leads to its failure. This danger exists especially with filter elements made of cordierite, since cordierite has a relatively low specific thermal capacity, and it is therefore possible that very high temperatures arise locally in the oxidation of particulate deposits.

Therefore, the present invention is based on the objective of providing a filter element made of a ceramic material, preferably cordierite, which is relatively insensitive to the heat released during the oxidation of the carbon-particulate deposits.

This object is achieved by a filter element, in particular for filtering exhaust gases of a diesel gasoline engine, having a longitudinal axis extending parallel to the main flow direction of the exhaust gas, a multitude of inlet channels extending parallel to the longitudinal axis, and a multitude of exit channels extending parallel to the longitudinal axis, the inlet channels and the exit channels being delimited by filter walls, in that the filter walls are at least partially coated.

### ADVANTAGES OF THE INVENTION

Due to the coating of the filter walls according to the present invention, their thermal inertia is increased, so that the temperature increase resulting from the release of heat during the carbon-particulate oxidation is reduced. This makes the filter element according to the present invention more resistant with respect to local differences in the loading by carbon particulate and with respect to local differences in the dissipation of the heat produced in the oxidation of the deposited carbon particulate.

According to the present invention, it is not necessary to coat the entire filter element. Instead, it is often already sufficient if the regions of the filter elements in which the highest operating temperatures occur are provided with a coating according to the present invention.

It is especially preferred in this context if the filter walls are coated on the inside of the inlet channels. This ensures that the thermal inertia of the filter walls is especially high precisely where the carbon particulate is deposited for the most part, i.e., on the inner sides of the inlet channels, so that the heat produced during the oxidation of the deposited carbon particulate does not lead to impermissibly high local temperatures inside the filter element.

Basically, all coatings that are chemically stable and inert with respect to the filter material, in particular cordierite, and which have a high volume- and/or mass-specific thermal capacity, are conceivable as coating materials. Any specific thermal capacity that is greater than the specific thermal capacity of the raw material of the filter element is considered high.

It has shown to be advantageous if the coating of the filter walls is made of oxides of the metals zirconium, cerium, lanthanum, titanium, and/or aluminum. The afore-mentioned marginal conditions, i.e., chemical stability, inert behavior with respect to the filter material, especially cordierite, temperature stability and high specific thermal capacity, are satisfied in the case of all these oxides.

In practical testing, it has been shown to be advantageous if the thickness of the coating is between 12 μm and 150 μm, preferably between 12 μm and 50 μm.

Of course, it is understood that the thickness of the coating may also differ locally in individual cases. This makes it possible to protect regions that are subjected to the highest thermal stresses against impermissibly high temperatures by a thicker layer than the regions of the filter element that are subjected to lower thermal stresses. As a rule, the regions about the longitudinal axis and at the rear end of the filter element viewed in the flow direction experience the greatest thermal stressing.

Especially preferred are coating materials that, in addition to the required properties such as chemical stability, inert response with respect to the filter material, in particular cordierite, temperature stability and high specific thermal capacity, have still other characteristics such as, for instance, catalytic characteristics.

The filter element according to the present invention preferably has filter walls having a porosity of between 40% and 65%, especially preferred between 45% and 55%.

It has also been shown to be advantageous if the cell density of the filter elements is between 100 cpsi (cpsi=cells per square inch) and 300 cpsi, preferably between 180 cpsi and 240 cpsi.

Aluminum oxide, magnesium silicate, preferably cordierite, titanium oxide, silicon carbide, and/or aluminum titanate have shown to be suitable materials for the filter walls of the filter element.

The performance of the filter element according to the present invention is enhanced further if the cross-sectional areas of the inlet channels and the cross-sectional areas of the exit channels are formed using a ratio between 2.0 and 1.0, preferably between 1.7 and 1.1. For then the inner side of the inlet channels is greater than the inside area of the exit channels. Since the filter element's storage capacity for carbon-particulate deposits is generally dependent upon the entrance area of the inside surface of the inlet channels, the geometry claimed according to the present invention increases the storage capacity of the filter elements for carbon particulate.

The advantages mentioned in the introduction are also achieved by a carbon-particulate filter having a filter element, a housing, a supply line, and a discharge line, in that a filter element according to the present invention is utilized.

Additional advantages and advantageous embodiments of the present invention may be found in the following drawing, its description and the claims. In this context, all the features described in the drawing, their specification and the claims may be essential to the present invention, both individually and in any combination with one another.

### BRIEF DESCRIPTION OF THE DRAWING

The figures show:

FIG. 1 a schematic illustration of an internal combustion engine having an exhaust-gas aftertreatment device according to the present invention;

FIG. 2 an exemplary embodiment of a filter element according to the present invention, in longitudinal section; and

FIG. 3 an enlarged cutaway from FIG. 2.

### DESCRIPTION OF THE EXEMPLARY EMBODIMENTS

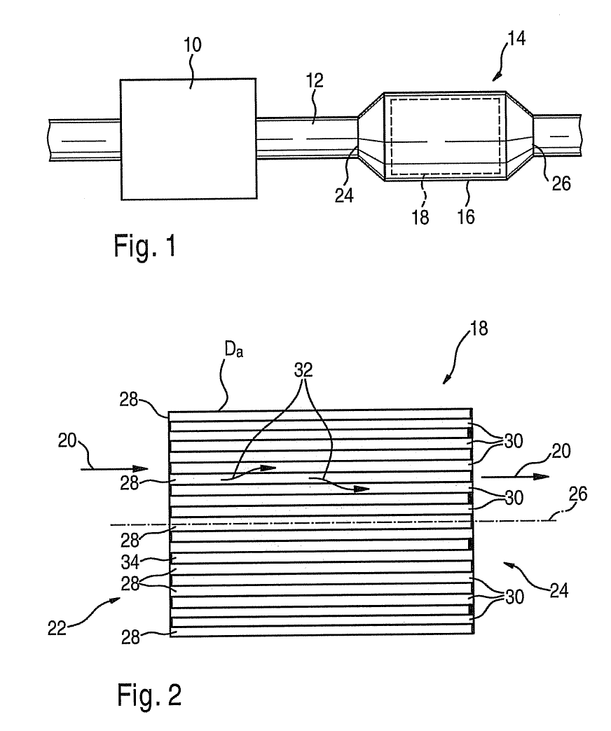

In FIG. 1, an internal combustion engine is denoted by reference numeral 10. The exhaust gases are carried away via an exhaust pipe 12 inside which a filter device 14 is disposed. It is used to filter carbon particulate out of the exhaust gas flowing inside exhaust pipe 12. This is required in particular in the case of diesel gasoline engines in order to comply with legal provisions.

In the exemplary embodiment shown in FIG. 1, filter device 14 includes a cylindrical housing 16 inside which a filter element 18 is disposed, which is a dynamically balanced in the exemplary embodiment and also has a cylindrical shape over all. The present invention is naturally not limited to these geometries.

FIG. 2 shows a cross section through a filter element 18 according to the related art. Filter element 18 is produced as an extruded molded body made of a ceramic material such as cordierite, for example. Exhaust gas, which is not shown, flows through filter element 18 in the direction of arrows 20. An entrance area bears reference numeral 22 in FIG. 2, while an exit area bears reference numeral 24 in FIG. 2.

A plurality of inlet channels 28 extends parallel to a longitudinal axis 26 of filter element 18, alternating with exit channels 30. Inlet channels 28 are sealed at exit area 24. The stoppers are shown without reference numerals in FIG. 2. In contrast, exit channels 30 are open at exit area 24 and sealed in the region of inlet surface 22.

The flow path of the unpurified exhaust gas thus leads into one of inlet channels 28 and from there through a filter wall (without reference numeral) into one of exit channels 30. This is shown by way of example by arrows 32.

The outer diameter of filter element 18 is denoted by Dₐ in FIG. 2.

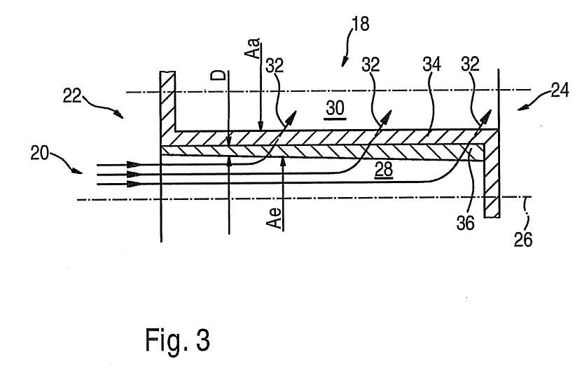

FIG. 3 shows a considerably enlarged cutaway of filter element 18 from FIG. 2 in a representation that is not true to scale. The enlarged illustration of filter element 18 illustrates that the inner walls of inlet channels 28 are coated by a coating 36. Of course, this coating 36 must be porous, like filter walls 34, so that the exhaust gases may travel both through coating 36 and through filter walls 34 from inlet channels 28 into exit channels 30. Since the thermal stressing of the filter element in the region of exit area 24 is greater than in the region of entrance area 22, thickness D of coating 36 increases in the direction of exit area 24.

Since, as already mentioned, coating 36 has a higher specific thermal capacity than filter walls 34, the thermal capacity of the filter element is adapted to its thermal loading by the locally differing thickness D of coating 36. On the one hand, this ensures that impermissibly high temperatures will not occur in the region of exit area 24 either, and on the other hand, that no unnecessarily thick coating 36 is provided in the region of entrance area 22.

Coating 36 may be applied using different conventional methods and methods known from the related art. One possible method consists of dipping filter element 18 into a suspension, which contains the materials that later form coating 36, and then subjecting it to a further heat treatment. In this case both sides of filter walls 34 would be coated.

A one-sided coating, as shown in FIG. 3, which is advantageous from technical and economical viewpoints, may be achieved, for instance, by filling filter element 18 with a suspension at entrance area 22, and then subjecting filter element 18 to a heat treatment.

Since a connection between entrance area 22 and exit channels 30 is possible only via the porous filter walls, this makes it possible to coat only the inner surfaces of inlet channels 28.

As an alternative, it is also possible to fill in the suspension at entrance area 22 and to apply a vacuum pressure at exit area 24 so that the suspension is aspirated through filter walls 34. The size of the grains contained in the suspension must be adapted to the size of the pores of filter elements 18 in such a way that the grains are deposited at the inner surface of inlet channels 28 and the fluid of the suspension is suctioned off through filter walls 34.

As an alternative, it would also be conceivable to draw a powder in air through filter element 18, by applying a pressure difference. The pressure on entrance area 22 is greater than the pressure on exit area 24, and the air mixed with powder is aspirated at entrance area 22 or blown into filter element 18.

Furthermore, it is also possible to fill filter element 18 with the suspension from the direction of entrance area 22, and then to impart a rotary motion to filter element 18, so that the suspension is pressed against filter walls 34, and the grains contained in the suspension thereby deposit on the inner surface of inlet channels 28.

1-15. (canceled)

16. A filter element, comprising:
a longitudinal axis extending parallel to a main flow direction of an exhaust gas;
a plurality of inlet channels extending parallel to the longitudinal axis; and
a plurality of exit channels extending parallel to the longitudinal axis;
wherein at least one of (a) the inlet channels and (b) the exit channels are delimited by filter walls, the filter walls being at least partially coated.

17. The filter element according to claim 16, wherein the filter element is adapted to filter exhaust gases of a diesel engine.

18. The filter element according to claim 16, wherein the filter walls are coated on an inside of the inlet channels.

19. The filter element according to claim 16, wherein a coating of the filter walls includes a material that is chemically stable and inert with respect to a filter material and which has at least one of (a) a high volume- and (b) a high mass-specific thermal capacity.

20. The filter element according to claim 19, wherein the filter walls include cordierite.

21. The filter element according to claim 19, wherein the coating of the filter walls includes an oxide of at least one of (a) zirconium, (b) cerium, (c) lanthanum, (d) titanium, and (e) aluminum.

22. The filter element according to claim 19, wherein a thickness of the coating is at least one of (a) between 12 μm and 150 μm and (b) between 12 μm and 50 μm.

23. The filter element according to claim 19, wherein a thickness of the coating differs locally.

24. The filter element according to claim 23, wherein the thickness of the coating is minimal in a region of an entrance area, and maximal in a region of an exit area.

25. The filter element according to claim 23, wherein the thickness of the coating is maximal in a region of the longitudinal axis and minimal in a region of an outer diameter.

26. The filter element according to claim 16, wherein a thickness of the filter walls is at least one of (a) between 12 mil and 25 mil and (b) between 17 mil and 22 mil.

27. The filter element according to claim 16, wherein a porosity of the filter walls is at least one of (a) between 40% and 65% and (b) between 45% and 55%.

28. The filter element according to claim 16, wherein a cell density of the filter walls is at least one of (a) between 100 cpsi and 300 cpsi and (b) between 180 cpsi and 240 cpsi.

29. The filter element according to claim 16, wherein the filter walls are made of at least one of (a) aluminum magnesium silicate, (b) cordierite, (c) titanium oxide, (d) silicon carbide, and (e) aluminum titanate.

30. The filter element according to claim 16, wherein the inlet channels begin at an entrance area of the filter element and are sealed at an exit area of the filter element, and the exit channels are sealed at the entrance area and end at the exit area.

31. The filter element according to claim 16, wherein cross-sectional areas of the inlet channels and cross-sectional areas of the exit channels form a ratio of at least one of (a) between 2.0 and 1.0 and (b) between 1.7 and 1.1.

32. A filter device, comprising:
a filter element;
a housing; and
an exhaust pipe;
wherein the filter element includes:
a longitudinal axis extending parallel to a main flow direction of an exhaust gas;
a plurality of inlet channels extending parallel to the longitudinal axis; and
a plurality of exit channels extending parallel to the longitudinal axis; and
wherein at least one of (a) the inlet channels and (b) the exit channels are delimited by filter walls, the filter walls being at least partially coated.
